(19) United States
(12) Patent Application Publication
(10) Pub. No.: US 2006/0227952 A1
(43) Pub. Date: Oct. 12, 2006

(54) Enhanced provision of low-cost professional services

(75) Inventors: Robert Jerold Cohen, Los Alamitos, CA (US); Antonio John Tavares, Mission Viejo, CA (US)

Correspondence Address: MCDERMOTT WILL & EMERY LLP, 18191 VON KARMAN AVE., SUITE 500, IRVINE, CA, 92612-7108, US

(73) Assignee: Legal Aid Society of Orange County

(21) Appl. No.: 11/399,444

(22) Filed: Apr. 7, 2006

Related U.S. Application Data
(60) Provisional application No. 60/670,283, filed on Apr. 12, 2005.

(51) Int. Cl. H04M 3/42; H04M 3/00

(52) U.S. Cl. 379/201.02; 379/201.03; 379/265.02; 379/114.05

(57) ABSTRACT

A method is provided for providing low-cost professional services. The method includes the steps collecting information from a user regarding a desired professional service, creating at least one electronic document based upon both the collected information and at least one of the plurality of professional service document forms, transmitting the at least one electronic document to a remote professional service provider for reviewing the at least one electronic document, and coordinating communication between the user and the remote professional service provider for approving or revising the at least one electronic document.

### CROSS-REFERENCE TO RELATED APPLICATION

The present application claims the benefit of priority under 35 U.S.C. §119 from U.S. Provisional Patent Application Ser. No. 60/670,283 entitled “ENHANCED PROVISION OF LOW-COST PROFESSIONAL SERVICES,” filed on Apr. 12, 2005, the disclosure of which is hereby incorporated by reference in its entirety for all purposes.

### FIELD OF THE INVENTION

The present invention generally relates to network-based conferencing and, more particularly, relates to the interactive provision of low-cost professional services over a secure network connection.

### BACKGROUND OF THE INVENTION

Oftentimes, members of the general public feel that competent professional service providers, such as doctors, attorneys, accountants, personal financial planners, business planners, and similar professionals, are unavailable to them, due to financial, geographic, cultural or other social barriers. In the legal field, for example, people who are contemplating filing bankruptcy typically cannot afford to take off time from their employer to visit an attorney during working hours, nor can they afford to pay often exorbitant legal fees in light of their accumulated debt. Furthermore, attorneys, faced with the tremendous overhead required to operate a viable law practice, typically cannot discount the provision of even relatively simple legal services to a price level low enough where those needing such services are able to pay.

As a result, willing clients are often unable to pay to receive competent services, and willing professional service providers are unable to operate a business by providing their services to those that need help the most. In the legal field, this situation has led to the establishment of quasi-professional “form preparation” businesses, where non-law trained franchisees talk clients through pre-printed forms, such as a simple will form, ostensibly without providing legal advice to the client.

From the perspective of the client, form preparers are a cost effective alternative to attorneys, and the completed form satisfies the clients need by providing a tangible work project, from what is assumed to be a trained quasi-professional. From the perspective of the professional legal community, however, these “form preparation” businesses often supply incorrect forms to clients, or induce clients to fill out a pre-printed form that may not resolve or even help a situation. In either of these situations, the client may end up in a worse legal situation than they were originally in, due to their decision to rely on non-law trained franchisees. In all cases, the monetary cost of “form preparation” establishments is high, since these franchisees can in many ways compete directly with lawyers and other professional service providers.

Accordingly, there is a need for a system which can connect clients who require assistance to professional service providers, who can provide such assistance. In particular, there is a need for low-cost professional services using a network of computers, which increase the availability of professional service providers to clients, while reducing overhead and increasing market visibility for the service provider. The present invention satisfies these needs and provides other advantages as well.

### SUMMARY OF THE INVENTION

In accordance with the present invention, a user can obtain low-cost professional services by using a personal computer or a publicly-accessible computer kiosk. Information is collected from the user by the computer in a question-and-answer format, and is combined with one or more document forms to create an electronic document. The electronic document is transmitted to a remote professional service provider who reviews the document and communicates with the user in real-time or in near-real-time regarding the electronic document using the computer or other means.

According to one aspect, the present invention is a method for providing low-cost professional services. The method includes the steps of collecting information from a user regarding a desired professional service, creating at least one electronic document based upon both the collected information and at least one of the plurality of professional service document forms, transmitting the at least one electronic document to a remote professional service provider for reviewing the at least one electronic document, and coordinating communication between the user and the remote professional service provider for approving or revising the at least one electronic document.

According to another aspect, the present invention is a computer usable medium having computer-readable program code for prompting a user to select a desired professional service, collecting information from the user regarding the desired professional service, providing, if necessary, instructional assistance to the user, accessing a database having a plurality of professional service document forms, creating at least one electronic document based upon both the collected information and at least one of the plurality of professional service document forms, transmitting the at least one electronic document to a remote professional service provider for reviewing the at least one electronic document, coordinating communication between the user and the remote professional service provider for approving or revising the at least one electronic document, and modifying, if necessary, the at least one electronic document, based upon input entered by the remote professional service provider and/or the user.

According to yet another aspect, the present invention is a system for providing low-cost professional services. The system includes a database having a plurality of professional service document forms and a computer configured to collect information from a user regarding a desired professional service, to create at least one electronic document based upon both the collected information and at least one of the plurality of professional service document forms, to modify, if necessary, the at least one electronic document, based upon input entered by a remote professional service provider and/or the user, and to collect, if desired, payment from the user. The system further includes means for transmitting the at least one electronic document to the remote professional service provider for reviewing the at least one electronic document and means for communication between the user and the remote professional service provider for approving or revising the at least one electronic document.

Additional features and advantages of the invention will be set forth in the description below, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE SEVERAL VIEWS OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a system for providing low-cost professional services according to one embodiment of the present invention;

FIG. 2 illustrates a computer kiosk for providing low-cost professional services according to another embodiment of the present invention;

FIG. 3 is a flowchart depicting a business method of providing low-cost professional services according to yet another embodiment of the present invention; and

FIG. 4 depicts a computer useable medium having computer-readable program code for providing low-cost professional services according to yet another embodiment of the present invention

### DETAILED DESCRIPTION OF THE INVENTION

In the following detailed description, numerous specific details are set forth to provide a full understanding of the present invention. It will be apparent, however, to one ordinarily skilled in the art that the present invention may be practiced without some of these specific details. In other instances, well-known structures and techniques have not been shown in detail to avoid unnecessarily obscuring the present invention.

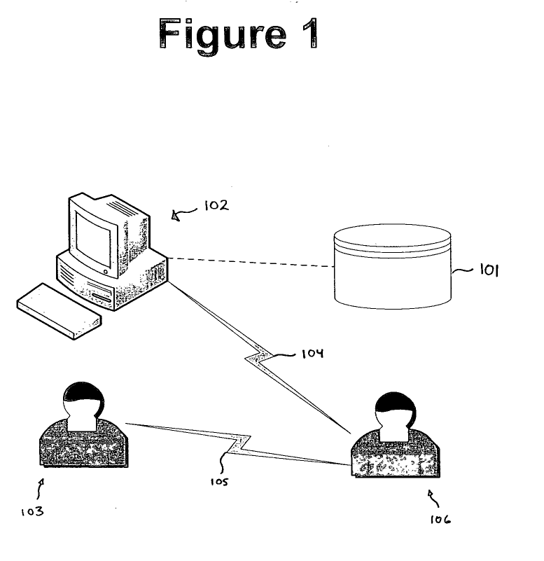

FIG. 1 illustrates a system for providing low-cost professional services according to one embodiment of the present invention. The system includes a computer 102 and a database 101, in which are stored document forms for various professional services. For example, database 101 may contain bankruptcy filing forms, or divorce filing forms, or a variety of other professional service document forms. Database 101 may be remotely located from computer 102, or may exist locally on a storage medium of computer 102.

Computer 102 is configured to prepare, for little or no cost, a professional service document for a user 103. The computer 102 is configured to collect information from the user 103 regarding a desired professional service (e.g., an adoption, a small claims case, eviction defense, etc.). The computer 102 may prompt the user 103 in a question-and-answer format for information such as the user's name, names of relevant parties, relevant dates, addresses, etc. The computer 102 may further prompt the user 103 with questions designed to help formulate an argument to include in the professional service document. The computer 102 is further configured to create one or more electronic documents based upon both the information received from the user 103 and the professional service document forms stored in the database 101.

Computer 102 includes a bus for communicating information, a processor coupled with the bus for processing information, memory such as random access memory (“RAM”) coupled to the bus for storing information and instructions to be executed by the processor. Computer 102 further includes a read only memory (“ROM”) or other static storage device coupled to the bus for storing static information or instructions for the processor. A storage device, such as a magnetic disk or optical disk, is provided and coupled to the bus for storing information and instructions. Computer 102 further includes a display for displaying information to the user 103 and a user input device for receiving instructions and information from user 103.

The system further includes messaging system 104 for transmitting the electronic document to a remote professional service provider 106, so the remote professional service provider 106 can review and/or modify the electronic document. According to one aspect of the present invention, the messaging system 104 for transmitting the electronic document to the professional service provider 106 may be a real-time or near-real-time system, such as a network connection between the computer 102 and a computer accessible to the remote professional service provider 106, such that an electronic message (e.g., an email, an instant message, or another computer alert) can be sent to the remote service provider 106. The network connection may be a local network connection, or may be routed through a wide area network, such as, for example, the internet. Alternatively, the messaging system 104 may be a modem and telephone connection, for transmitting the electronic document over telephone lines in real-time or near-real-time to a computer or facsimile machine accessible to the remote professional service provider 106. In other embodiments, the messaging system 104 may be a telephonic or network connection to an intermediary coordinator, who receives the electronic document, and transmits it to a remote professional service provider 106.

The system further includes communication link 105 for communication between the user 103 and the remote professional service provider 106 in real-time or near-real-time. According to one aspect of the present invention, these communication link 105 may include a videoconference connection between the user 103 and the remote professional service provider 106, using the computer 102 and a computer accessible to the remote professional service provider 106. Alternatively, the communication link 105 for communication may be a two-way audio connection between the user 103 and the remote professional service provider 106 such as, for example, a telephone connection or an audio connection using the computer 102 and either a computer accessible to the remote professional service provider 106 or a telephone accessible to the remote professional service provider 106. In still other embodiments, the communication link 105 for communication may be a text-based system, such as, for example, internet relay chat (“IRC”) or an instant messenger program, for the user 103 and remote professional service provider 106 to communicate using their respective computers. In yet another embodiment, the communication link 105 for communication may be software which provides a shared computer workspace in which both the user 103 and the remote professional service provider 106 can view and manipulate an electronic document.

With the user 103 in contact with the remote professional service provider 106, and the remote professional service provider 106 able to review the electronic document, the remote professional service provider 106 is able to provide professional services, such as a review of the document, advice as to how to modify or file the electronic document, modification of the document, etc. The computer 102 is configured to permit the user 103 or the remote professional service provider 106 to modify the electronic document based upon local input at the computer 102 or remote input from the remote professional service provider 106. If the remote professional service provider 106 determines that the electronic document will not be sufficient for the user 103, he or she may use the communication link 105 for communication between them to refer the user 103 to another professional service provider, or to recommend the user 103 make an appointment to see the remote professional service provider 106 (e.g., a self-referral).

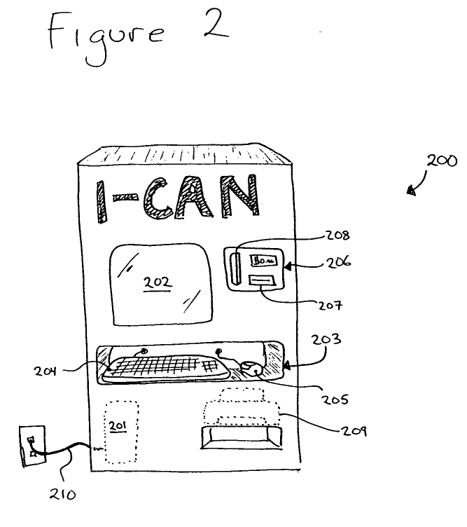

According to one embodiment, computer 102 is a personal or home computer on which user 103 connects to a remote network, such as, for example, the internet. According to another embodiment, computer 102 may be a publicly accessible computer kiosk, as illustrated in greater detail in FIG. 2. Computer kiosk 200 includes processor 201, display 202 and any of a number of input devices 203, such as keyboard 204 and mouse 205. According to one embodiment, display 202 is a touch-sensitive display which functions as an input device. Computer kiosk 200 further includes payment collector 206. Payment collector 206 includes currency acceptor 207 and electronic reader 208. Currency acceptor 207 is configured to accept coin or paper currency, or both. Electronic reader 208 is configured to accept electronic payment forms such as, for example, credit cards, debit cards, prepaid cards and the like.

Computer kiosk 200 further includes printer 209 for printing documents and connection means 210 for communicating with remote computers and or networks. Means 210 may be a network connection between the computer kiosk 200 and a remote computer, such that an electronic message (e.g., an email, an instant message, or another computer alert) can be sent to the remote computer. The network connection may be a local network connection, or may be routed through a wide area network, such as, for example, the internet. Alternatively, the means 210 may be a modem and telephone connection, for transmitting an electronic document over telephone lines to a computer or facsimile machine accessible to a remote professional service provider. In other embodiments, the means 210 may be a telephonic or network connection to an intermediary coordinator, who receives an electronic document and transmits it to a remote professional service provider.

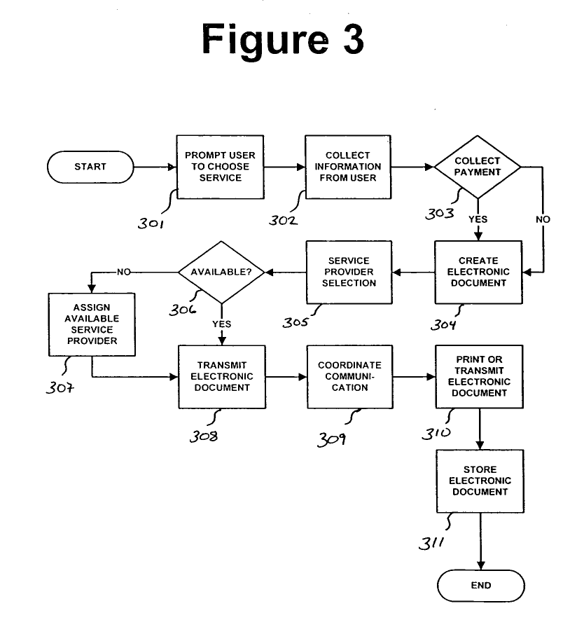

FIG. 3 is a flowchart depicting a business method of providing low-cost professional services according to another embodiment of the present invention. In step 301, a user is prompted, using a computer, to choose a desired professional service. In one embodiment of the invention, a computer terminal or computer kiosk might provide a user with a choice of different available professional services, such as, for example, bankruptcy filing, divorce filing or eviction defense. In alternate embodiments, other professional services may also be available, or only one professional service may be available. In an embodiment where only one professional service is available, the prompting step 301 might consist simply of the user activating a computer session, thereby confirming his or her desire for the only available professional service at that computer.

In one embodiment, the user who has previously used the computer is prompted for a user name and password, to resume work on a previously begun electronic document. A user name and password are not necessary, however, to use the computer, and the user is presented with logging in as an option, not a requirement.

In step 302, a computer is used to collect information from the user regarding the desired professional service. In one embodiment, the computer may be configured to use a “question-and-answer” style of prompting the user for information in straightforward language. In another embodiment, the computer may be configured to provide a fill-in-the-blank style of prompting the user for information. The question-and-answer style, however, is preferred, as it permits a user with little or no sophistication regarding the professional service to prepare an otherwise dauntingly complicated document. Moreover, the question-and-answer style of prompting the user may enable a user with limited or no literacy skills to prepare a document, when the question-and-answer prompting is coupled with information assistance, as described more fully below.

The kind of information collected from the user may depend, at least in part, on the professional service the user is seeking. For example, in an embodiment of the invention applicable to bankruptcy petitions, the user may be prompted to provide his or her name, address, marital status, number of children, names of creditors, amount owed, values of assets, and the like. In another embodiment of the invention, applicable to a user seeking to fight an eviction, the user may be asked about the status of his or her rental property, the behavior of his or her landlord, and details of the documents with which the user has already been served.

If at any point during the process the user requires assistance, he or she can indicate this need to the computer and receive instructional assistance. For example, in one embodiment, the user may be provided with an instructional video and/or audio presentation if the user indicates that he or she requires assistance with one of the question-and-answer style prompts. In one embodiment of the invention, applicable to an eviction defense, the user may be prompted with a question regarding a notice to quit with which he or she has been served. In this case, if the user indicates the need for assistance by, for example, pressing a help button, an instructional video and/or audio presentation describing or showing the notice to quit, indicating where on the notice to quit to find the necessary information, and how to enter the information into the computer. In one embodiment of the present invention applicable to users with limited or no literacy skills, the instructional assistance may include having the questions read aloud to the user.

In step 303, payment may be collected from the user, if desired. According to one embodiment, the user pays with an electronic payment form, such as, for example, a credit card, debit card, or prepaid card, at the computer. According to another embodiment, the user pays with cash, using either in a bill acceptor at the computer or by paying a facilitator in a legal resolution center, who then enters a password to allow the user to proceed. In still another embodiment applicable to pro bono cases, the user may not be prompted to pay at all.

While the present exemplary embodiment has described collecting payment from the user after the collection of information and prior to the creation of an electronic document, the scope of the present invention is not limited to such an arrangement. Payment may be collected from the user at any point during the process, or not at all.

In step 304, the computer creates an electronic document based upon both the information collected from the user and one or more professional service document forms stored in a database of forms. For example, in an embodiment of the invention applicable to a user seeking to file for divorce, the computer will combine the information collected from the user, such as, for example, his or her name, his or her spouse's name, the date of marriage, the date of marital separation, the reason for seeking the divorce, etc., with a professional service document form from the database, to create a pleading filing for divorce. In an alternate embodiment applicable to a user seeking to file a bankruptcy petition, the computer may combine personal and financial information collected from the user with a bankruptcy petition form to create a bankruptcy petition for the user.

According to one aspect of the present invention, a database of professional service document forms is maintained remotely from the computer. The maintenance of the database may include adding and updating document forms for various professional services and localities. For example, in one embodiment of the invention applicable to bankruptcy services, the maintenance of the database includes updating the language and format of bankruptcy filing forms as the laws, codes and rules for the various localities in which bankruptcy filing is available change. Further, in this exemplary embodiment, the maintenance includes adding new forms to the database as additional professional services are made available to users.

The electronic document will be displayed to the user on the computer screen, but will not yet be available for printing or filing with a third party, such as a court or administrative body. Rather, the user will be able to review the document for errors in the entered data on screen, before the electronic document is transmitted to a remote professional service provider for review, revision or referral.

In some embodiments of the present invention, the user may be prompted to choose a professional service provider to whom the electronic document will be transmitted from a list of such providers provided by the computer in step 305. The list of providers may be generated by the computer based upon the information collected from the user in step 302, such as, for example, information pertaining to the location of the user. The list of providers may alternately be generated by the computer based upon information provided by the professional service providers regarding their availability, foreign language skills, caseload and the like. In alternate embodiment, this choosing step is omitted, and a professional service provider is selected for the user by the computer.

In embodiments in which this choosing step is included, the availability of the chosen professional service provider is determined in step 306. The availability of the chosen professional service provider may be determined by remotely polling (e.g., by telephone or network connection) the professional service provider to see if the professional service provider is available, or by comparing the chosen professional service provider against a list of currently available professional service providers in the jurisdiction of the user that is maintained by the computer, or maintained in the database. If the chosen professional service provider is not available, an alternate professional service provider who is available is assigned to the user in step 307. The available professional service provider may be automatically assigned by the computer based upon a list of available providers, or the user may be prompted to choose another professional service provider. Once a professional service provider who is available is chosen, the process continues to step 308.

In step 308, the electronic document is transmitted to the remote professional service provider. According to one aspect of the present invention, the means for transmitting the electronic document to the professional service provider may be a real-time or near-real-time system, such as a network connection between the computer and another computer accessible to the remote professional service provider, such that an electronic message (e.g., an email, an instant message, or another computer alert) can be sent to the remote service provider. The network connection may be a local network connection, or may be routed through a wide area network, such as, for example, the internet. According to one aspect, the electronic document is sent via a secure connection, such as, for example, a secure socket layer (SSL) connection. According to another aspect, the electronic document is encrypted before being transmitted. Alternatively, the means may be a modem and telephone connection, for transmitting the electronic document over telephone lines to a computer or facsimile machine accessible to the remote professional service provider. In other embodiments, the means may be a telephonic or network connection to an intermediary coordinator, who receives the electronic document, and transmits it to a remote professional service provider.

In one embodiment, the transmission step includes storing a copy of the electronic document either locally on a storage medium of the computer, such as a hard drive, non-volatile memory, or the like, or alternatively on a remote server or database. The electronic document is stored so that the user can leave the computer and return later to resume work on an incomplete document. This storing step becomes important in an embodiment in which the transmission and communication steps are not real-time or near-real-time. The storing step may include prompting the user to create a user name and password or to associate a previously created user name and password with the electronic document.

In one embodiment, the professional service provider may receive conflict of interest data regarding the user along with the electronic document, so that the professional service provider may perform any necessary conflict of interest check prior to reviewing the electronic document. For example, in an embodiment of the invention applicable to a user seeking to file divorce, the conflict of interest data may include the name of the user and the names of the user's spouse and children, so that the professional service provider (in this case, a divorce attorney), can ensure his or her compliance with any applicable conflict of interest laws. In other embodiments, the conflict of interest data may include other identifying information about the user, such as, for example, the user's address, social security number or other tax identification number, or any other identifying data, as will be apparent to those of skill in the art.

If the professional service provider determines that a conflict exists, he or she can indicate the conflict to the computer, which will then either prompt the user to select another professional service provider, or automatically select another professional service provider for the user. Once a professional service provider without a conflict of interest is selected, he or she will review the electronic document.

Communication between the professional service provider and the user is coordinated in step 309. In one embodiment, the communication may be a videoconference connection between the user and the remote professional service provider, using the computer and a computer accessible to the remote professional service provider. Alternatively, a two-way audio connection between the user and the remote professional service provider may be provided. For example, a telephone connection or an audio connection using the computer or a telephone accessible to the user, and either a computer or a telephone accessible to the remote professional service provider. In still other embodiments, a text-based system, such as, for example, internet relay chat (“IRC”) or an instant messenger program, may be provided for the user and remote professional service provider to communicate using their respective computers. In yet other embodiments, software may provide a shared computer workspace, in which both the user and the professional service provider can view and manipulate the electronic document.

While the present exemplary embodiment has described communication between the professional service provider and the user being coordinated after the professional service provider reviews the electronic document, the scope of the present invention is not limited to such an arrangement. Communication between them may be coordinated prior to the review of the electronic document, or during review of the electronic document.

The remote professional service provider communicates with the user to regarding the electronic document and provides his or her professional service to the user. For example, in an embodiment applicable to a user seeking to file divorce, a divorce attorney would review the divorce filing document created by the computer for completeness, accuracy, and legal efficacy, and would provide his or her comments on the document to the user. If, in the opinion of the attorney, any changes need to be made to the document, either the attorney could direct the user to make the changes, or the attorney could make the changes. When the attorney is satisfied that the document is in a condition suitable for filing, the attorney would indicate that fact to the user. If the user had any questions regarding the filing of the document, the attorney could provide the answers. Alternatively, if the document is not in a condition suitable for filing, either because the scenario requires additional legal assistance, the attorney can use the communication link to invite the user to retain the attorney (i.e., self-referral), or refer the user to another attorney suited to the needs of the user.

Once the electronic document is completed to the satisfaction of the user and the professional service provider, the electronic document is either printed or transmitted to a third party for filing in step 310. In one embodiment, the involvement of the professional service provider ends at this point, and the user remains responsible for ensuring that the electronic document is filed. For example, in an embodiment in which the user and the computer are located in a court building, the user may print the electronic document from a printer attached to the computer, and carry the document to the appropriate clerk for filing. In an alternate embodiment in which the user and the computer are remotely located from the third party with whom the electronic document needs to be filed, the user may transmit the electronic document to the third party, using a network connection, modem connection, or the like, as described more fully above. For example, if the user has prepared a bankruptcy petition using a home computer connected to the internet, the user may electronically sign the document and transmit it to the bankruptcy court without needing to leave his or her home. In alternate embodiments, the professional service provider may be responsible for filing the electronic document, if such an agreement is reached between the user and the professional service provider.

In step 311, the electronic document is stored for later access. The electronic document may be stored in the database in which document forms are stored, or it may be stored in a separate database or storage medium. The electronic document is stored so that the user and/or the professional service provider can later retrieve the electronic document for review or revision. According to one embodiment, the electronic document is stored on a remote server with differing levels of secured access to the electronic document. The user may be permitted to retrieve the electronic document, using a previously assigned user name and password, for a certain period of time, such as, for example, three months. The professional service provider, using a separate name and password, may be permitted to retrieve the electronic document for the same or a different period of time, such as, for example, two weeks. Alternatively, the professional service provider may not be permitted to retrieve the electronic document, according to the preference of the user. Even after the user's period of access has expired, the electronic document may continue to be stored for a variety of reasons, such as, for example, compliance purposes.

While the present exemplary embodiment has been described as assisting a user with bankruptcy or divorce, the present invention is not limited to any particular professional services. Rather, the scope of the present invention includes any professional service, such as, for example, tax preparation assistance, license denial review, obtaining a child support order, establishing a parental relationship, unlawful detainer defense, fee waiver assistance, and the like.

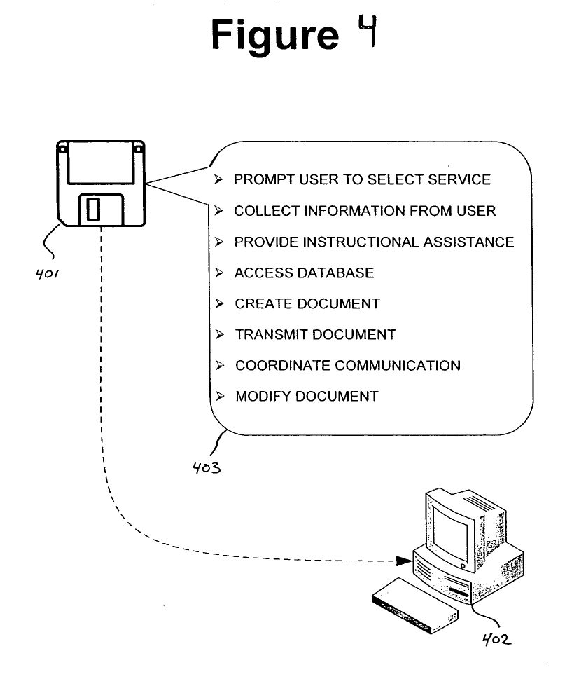

FIG. 4 depicts a computer useable medium 401 having computer-readable program code 403 for providing low-cost professional services according to another embodiment of the present invention. Program code 403 includes computer executable code for prompting a user to select a desired professional service, collecting information from the user regarding the desired professional service, providing, if necessary, instructional assistance to the user, accessing a database having a plurality of professional service document forms, creating at least one electronic document based upon both the collected information and at least one of the plurality of professional service document forms, transmitting the at least one electronic document to a remote professional service provider for reviewing the at least one electronic document, coordinating communication between the user and the remote professional service provider for approving or revising the at least one electronic document or for referring the user to the remote professional service provider or another professional service provider, and modifying, if necessary, the at least one electronic document, based upon input entered by the remote professional service provider and/or the user.

While the computer useable medium 401 depicted in FIG. 4 is a computer diskette, it will be understood by one of skill in the art that a computer useable medium of the present invention includes any medium readable by a computer 402, such as, for example, a hard disk, magnetic tape, any other magnetic medium, a compact disc (“CD”), a digital video disc (“DVD”), any other optical medium, RAM, PROM, EPROM, EEPROM, flash memory, any other memory chip or cartridge, or any other medium from which a computer can read.

While the present invention has been particularly described with reference to the various figures and embodiments, it should be understood that these are for illustration purposes only and should not be taken as limiting the scope of the invention. There may be many other ways to implement the invention. Many changes and modifications may be made to the invention, by one having ordinary skill in the art, without departing from the spirit and scope of the invention.

What is claimed is:

1. A method for providing low-cost professional services, the method comprising the steps of:
collecting information from a user regarding a desired professional service;
creating at least one electronic document based upon both the collected information and at least one of the plurality of professional service document forms;
transmitting the at least one electronic document to a remote professional service provider for reviewing the at least one electronic document; and
coordinating communication between the user and the remote professional service provider for approving or revising the at least one electronic document.

2. The method of claim 1, further comprising the step of maintaining a database having a plurality of professional service document forms.

3. The method of claim 1, further comprising the step of collecting payment from the user.

4. The method of claim 1, further comprising the step of prompting the user to choose the desired professional service.

5. The method of claim 1, further comprising the step of prompting the user to choose the remote professional service provider from a list of remote professional service providers.

6. The method of claim 5, wherein if the remote professional service provider chosen by the user is unavailable, the user is assigned another remote professional service provider automatically.

7. The method of claim 1, further comprising the step of printing the at least one electronic document or transmitting the at least one electronic document to a third party for filing.

8. The method of claim 1, further comprising the step of storing the at least one electronic document for later access by the user and/or the remote professional service provider.

9. The method of claim 1, wherein the coordinating step includes referring the user to the remote professional service provider.

10. The method of claim 1, wherein the collecting information step includes employing audio and/or video prompts for collecting the information from a user with limited literacy skills.

11. The method of claim 1, wherein the transmitting step includes emailing the at least one electronic document to the remote professional service provider.

12. The method of claim 1, wherein the transmitting step includes transmitting conflict of interest data to the remote professional service provider.

13. The method of claim 1, wherein the transmitting step includes transmitting the at least one electronic document to a coordinator, and further includes the coordinator transmitting the at least one electronic document to the remote professional service provider.

14. The method of claim 1, wherein the coordinating step includes providing a videoconference connection between the user and the remote professional service provider.

15. The method of claim 1, wherein the coordinating step includes providing a two-way audio connection between the user and the remote professional service provider.

16. The method of claim 1, wherein the remote professional service provider is an attorney.

17. A system for providing low-cost professional services, the system comprising:
a database having a plurality of professional service document forms;
a computer configured to:
collect information from a user regarding a desired professional service,
create at least one electronic document based upon both the collected information and at least one of the plurality of professional service document forms,
modify, if necessary, the at least one electronic document, based upon input entered by a remote professional service provider and/or the user, and
collect, if desired, payment from the user;
means for transmitting the at least one electronic document to the remote professional service provider for reviewing the at least one electronic document; and
means for communication between the user and the remote professional service provider for approving or revising the at least one electronic document.

18. The system of claim 17, wherein the computer is remotely located from the database, and wherein the computer is configured to access the database using a network connection.

19. The system of claim 17, wherein the computer is a publicly-accessible computer kiosk including a display, an input device, and a payment collector.

20. A computer usable medium having computer-readable program code for:
prompting a user to select a desired professional service;
collecting information from the user regarding the desired professional service;
accessing a database having a plurality of professional service document forms;
creating at least one electronic document based upon both the collected information and at least one of the plurality of professional service document forms;
transmitting the at least one electronic document to a remote professional service provider for reviewing the at least one electronic document;
coordinating communication between the user and the remote professional service provider for approving or revising the at least one electronic document; and
modifying, if necessary, the at least one electronic document, based upon input entered by the remote professional service provider and/or the user.

21. The computer usable medium of claim 20, wherein the computer-readable program code is also for providing, if necessary, instructional assistance to the user.

22. The computer usable medium of claim 21, wherein the instructional assistance includes multimedia presentations including audio and/or video content.

23. The computer usable medium of claim 20, wherein the transmitting the at least one electronic document to a remote professional service provider includes emailing the at least one electronic document to a remote professional service provider.

24. The computer usable medium of claim 20, wherein the coordinating communication includes providing an audio and/or videoconference connection between the user and the remote professional service provider.
